(19) United States
(12) Patent Application Publication
(10) Pub. No.: US 2014/0164373 A1
(43) Pub. Date: Jun. 12, 2014

(54) SYSTEMS AND METHODS FOR ASSOCIATING MEDIA DESCRIPTION TAGS AND/OR MEDIA CONTENT IMAGES

(71) Applicant: RAWLLIN INTERNATIONAL INC., Tortola (VG)

(72) Inventor: Leonid Belyaev, Moscow (RU)

(73) Assignee: RAWLLIN INTERNATIONAL INC., Tortola (VG)

(21) Appl. No.: 13/709,636

(22) Filed: Dec. 10, 2012

(51) Int. Cl. G06F 17/30

(52) U.S. Cl. CPC G06F 17/30386
USPC 707/736

(57) ABSTRACT

Systems and methods for associating tagged data in media content and/or media content images are disclosed herein. A tag is assigned to a content element in a media item. The tag is associated with one or more other tags based at least in part on information associated with the tag.

### TECHNICAL FIELD

This disclosure generally relates to tagged data in media content.

### BACKGROUND

Multimedia such as video in the form of clips, movies, television and streaming video is becoming widely accessible to users (e.g., computer users). As such, the amount of content provided to users via multimedia is increasing. However, currently users are required to actively search for additional information associated with content provided by multimedia. Since users often have limited knowledge of the content presented in multimedia, obtaining additional information associated with multimedia content is often difficult and/or inefficient. Furthermore, users are often times unsuccessful in obtaining additional information associated with multimedia content. In addition, conventional multimedia systems and methods are not able to control and/or manage additional content associated with multimedia content.

The above-described deficiencies associated with tagged data in media content are merely intended to provide an overview of some of the problems of conventional systems, and are not intended to be exhaustive. Other problems with the state of the art and corresponding benefits of some of the various non-limiting embodiments may become further apparent upon review of the following detailed description.

### SUMMARY

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments in a simplified form as a prelude to the more detailed description of the various embodiments that follow.

In accordance with one or more embodiments and corresponding disclosure, various non-limiting aspects are described in connection with associating media description tags and/or media content images. For instance, an embodiment includes a system comprising a tagging component and a matching component. The tagging component is configured to assign a tag to a content element in a media item. The matching component is configured to associate the tag with one or more other tags based at least in part on information associated with the tag.

In another non-limiting embodiment, an exemplary method is provided that includes locating a content element in a media item, assigning a tag to the content element in the media item, and associating the tag with at least one other tag based at least in part on information associated with the tag.

In yet another non-limiting embodiment, an exemplary method is provided that includes assigning, by the system, an image to a content element in a media item, and associating, by the system, the image with one or more other images based on information associated with the image.

In still another non-limiting embodiment, an exemplary tangible computer-readable storage medium comprising computer-readable instructions that, in response to execution, cause a computing system including a processor to perform operations, comprising locating a content element in a media item, assigning a tag and an image to the content element in the media item, and associating the tag with one or more other tags based at least in part on information associated with the tag.

Other embodiments and various non-limiting examples, scenarios and implementations are described in more detail below. The following description and the drawings set forth certain illustrative aspects of the specification. These aspects are indicative, however, of but a few of the various ways in which the principles of the specification may be employed. Other advantages and novel features of the specification will become apparent from the following detailed description of the specification when considered in conjunction with the drawings.

### BRIEF DESCRIPTION OF THE DRAWINGS

Numerous aspects, embodiments, objects and advantages of the present invention will be apparent upon consideration of the following detailed description, taken in conjunction with the accompanying drawings, in which like reference characters refer to like parts throughout, and in which:

FIG. 1 illustrates a high-level functional block diagram of an example system for associating tagged data in media content, in accordance with various aspects and implementations described herein;

FIG. 2 illustrates another high-level functional block diagram of an example system for associating tagged data in media content, in accordance with various aspects and implementations described herein;

FIG. 3 illustrates yet another high-level functional block diagram of an example system for associating tagged data in media content, in accordance with various aspects and implementations described herein;

FIG. 4 illustrates a high-level functional block diagram of an example system for presenting tagged data in media content, in accordance with various aspects and implementations described herein;

FIG. 5 presents an exemplary representation of content elements in a media item assigned to tags and/or keyimages, in accordance with various aspects and implementations described herein;

FIG. 6 presents an exemplary representation of a tag and/or a keyimage associated with one or more groups, in accordance with various aspects and implementations described herein;

FIG. 7 presents an exemplary representation of a first tag and/or a first keyimage associated with one or more groups and a second tag and/or a second keyimage associated with one or more groups, in accordance with various aspects and implementations described herein;

FIG. 8 presents an exemplary representation of one or more groups presented on a device, in accordance with various aspects and implementations described herein;

FIG. 9 presents an exemplary representation of one or more tags and/or keyimages presented on a device, in accordance with various aspects and implementations described herein;

FIG. 10 illustrates a method for associating tagged data in media content, in accordance with various aspects and implementations described herein;

FIG. 11 illustrates another method for associating tagged data in a particular media content to other media content, in accordance with various aspects and implementations described herein;

FIG. 12 illustrates a method for associating media content images, in accordance with various aspects and implementations described herein;

FIG. 13 illustrates a method for grouping tagged data in media content, in accordance with various aspects and implementations described herein;

FIG. 14 illustrates another method for grouping tagged data in media content, in accordance with various aspects and implementations described herein;

FIG. 15 illustrates a method for receiving tagged data in media content, in accordance with various aspects and implementations described herein;

FIG. 16 illustrates another method for receiving tagged data in media content, in accordance with various aspects and implementations described herein;

FIG. 17 illustrates a block diagram representing exemplary non-limiting networked environments in which various non-limiting embodiments described herein can be implemented; and

FIG. 18 illustrates a block diagram representing an exemplary non-limiting computing system or operating environment in which one or more aspects of various non-limiting embodiments described herein can be implemented.

### DETAILED DESCRIPTION

In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment,” or “an embodiment,” means that a particular feature, structure, or characteristic described in connection with the embodiment is included in at least one embodiment. Thus, the appearances of the phrase “in one embodiment,” or “in an embodiment,” in various places throughout this specification are not necessarily all referring to the same embodiment. Furthermore, the particular features, structures, or characteristics may be combined in any suitable manner in one or more embodiments.

As utilized herein, terms “component,” “system,” “interface,” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In an aspect, a component can emulate an electronic component via a virtual machine, e.g., within a cloud computing system.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

In addition, the disclosed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable media. For example, computer-readable media can include, but are not limited to, a magnetic storage device, e.g., hard disk; floppy disk; magnetic strip(s); an optical disk (e.g., compact disk (CD), a digital video disc (DVD), a Blu-ray Disc™ (BD)); a smart card; a flash memory device (e.g., card, stick, key drive); and/or a virtual device that emulates a storage device and/or any of the above computer-readable media.

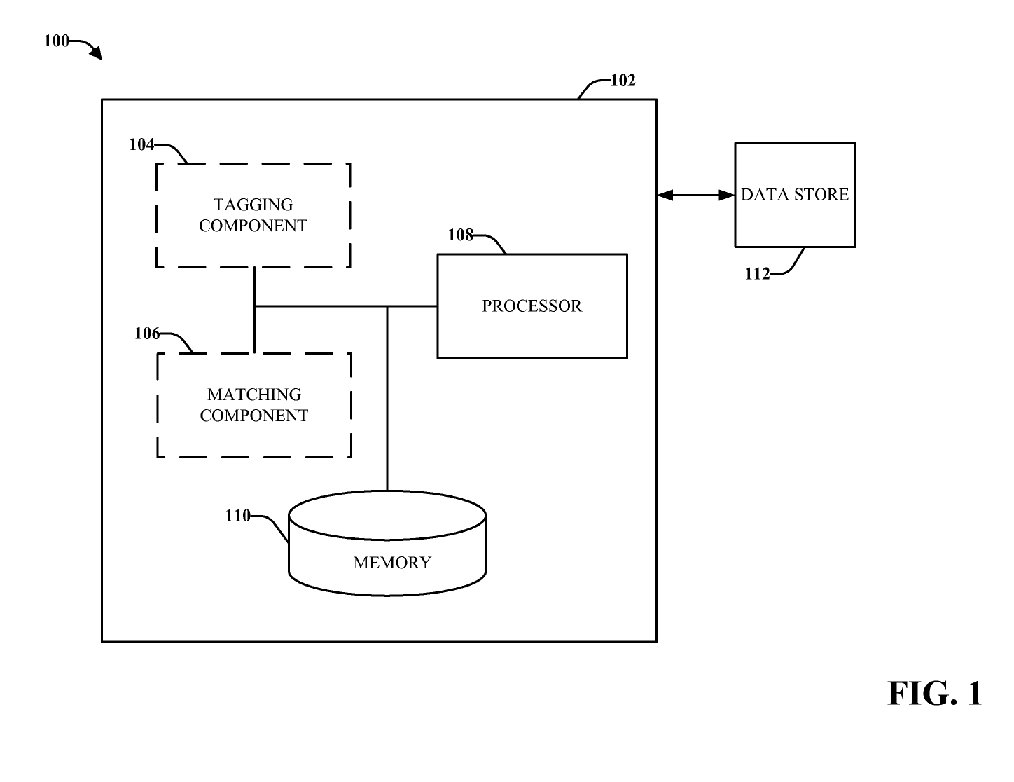

Referring now to the drawings, with reference initially to FIG. 1, a system 100 for associating tagged content elements (e.g., media description tags) in a media item and/or media content images is presented, in accordance with various aspects described herein. Aspects of the systems, apparatuses or processes explained herein can constitute machine-executable component embodied within machine(s), e.g., embodied in one or more computer readable mediums (or media) associated with one or more machines. Such component, when executed by the one or more machines, e.g., computer(s), computing device(s), virtual machine(s), etc. can cause the machine(s) to perform the operations described. System 100 can include a memory 110 for storing computer executable components and instructions. A processor 108 can facilitate operation of the computer executable components and instructions by the system 100.

The system 100 is configured to associate tagged content elements (e.g., a media description tag), content associated with a tagged content element in a media item and/or media content images. The system 100 includes a component 102. The component 102 includes a tagging component 104 and a matching component 106. The tagging component 104 can be configured to assign a tag to a content element in a media item. The tagging component 104 can also be configured to assign the tag to an image associated with the content element. The matching component 106 can be configured to associate the tag with one or more other tags based at least in part on information associated with the tag. As such, one or more related tags, one or more related images one or more related content elements and/or one or more related media items can be determined.

As used herein, a “tag” is a keyword assigned to a content element (e.g., associated with a content element) in a media item. Information associated with the tag can include, for example, text, images, links, comments, detailed description, a description, a timestamp, ratings, purchase availability, coupons, discounts, advertisements, etc. In an aspect, a tag can help to describe a content element assigned to (e.g., associated with) the tag. As used herein, a “content element” is an element presented in a media item (e.g., a video). A content element can include, but is not limited to, an object, a product, a good, a device, an item of manufacture, a person, an entity, a geographic location, a place, an element, etc. In one implementation, a content element can be identified during film production of media content (e.g., a media item). For example, during film production of a movie, television show or other video clip, one or more content elements can be identified (e.g., one or more content elements can be identified in a scene of the media content where the media content is virtually split into scenes). In another implementation, a content element can be identified after film production of media content (e.g., a media item). For example, during playback of media content a user (e.g., a content consumer, a viewer, a sponsor, etc.) can identify and/or add one or more content elements (e.g., via a user device). As used herein, the term “media item” or “media content” is intended to relate to an electronic visual media product and includes video, television, streaming video and so forth. For example, a media item can include a movie, a live television program, a recorded television program, a streaming video clip, a user-generated video clip, a video game, etc. As used herein, a “keyimage” is a media content image associated with a content element in a media item.

The tagging component 104 can assign a tag to (e.g., associate a tag with) each identified content element in a media item. For example, a tag can be associated with one or more keywords. In another example, a tag can be associated with metadata. Additionally or alternatively, the tagging component 104 can assign the tag to an image (e.g., a keyimage) associated with the content element. In one embodiment, the tagging component 104 can assign an image (e.g., a thumbnail image, an image associated with a content element, etc.) to the content element in the media item (e.g., without assigning a tag to the content element in the media item). An image associated with the content element and/or the tag can be implemented as a keyimage. A keyimage can be associated with one or more keywords and/or a tag. Additionally or alternatively, a keyimage can be associated with other information. The keyimage can allow a user to interact with a content element and/or a tag associated with a content element. For example, information associated with a tag and/or a content element can be presented to a user in response to a user activating (e.g., clicking, pushing, etc.) a keyimage (e.g., a keyimage icon). In one example, a keyimage can be implemented as a thumbnail image displayed next to a media player (e.g., a media player that presents a media item). In another example, a keyimage can be implemented as a thumbnail image displayed on a device (e.g., a smartphone, etc.) separate from a device (e.g., a television, a computer, etc.) that presents a media item. As such, a keyimage can be activated during playback of a video content sequence and/or after playback of a video content sequence.

The tagging component 104 can assign a value to a tag identifying the content element. For example, each content element in a media item can include a uniquely assigned value and/or a uniquely assigned tag. As such, the tagging component 104 can generate one or more tagged content elements. Additionally or alternatively, the tagging component 104 can assign a value to an image (e.g., a keyimage) identifying the content element. For example, each content element in a media item can be associated with an image (e.g., an image thumbnail, an image icon, etc.) that includes a uniquely assigned value.

Additionally, the tagging component 104 can assign information regarding a content element (e.g., information associated with a content element) to a tag (e.g., a tagged content element). Information can include, but is not limited to, one or more keywords, detailed information, a description, other text, a location of a tag within a media item (e.g., a timestamp), an image, purchase availability of a content element associated with a tag, one or more links to one or more information sources (e.g., a uniform resource locator (URL)), etc.

In one embodiment, the tagging component 104 can determine and/or set the number of content elements in a media item. For example, the tagging component 104 can determine one or more content elements included in a media item, set type of content elements (e.g., objects, products, goods, devices, items of manufacture, persons, entities, geographic locations, places, elements, etc.) that can be tagged, etc. In one embodiment, the tagging component 104 can be configured to identify one or more content elements in the media item. For example, the tagging component 104 can implement auto-recognition (e.g., an image recognition engine) to identify one or more content elements. In one example, a particular content element can be initially identified in a scene (e.g., a video frame, a certain time interval, etc.) of a media item by a user (e.g., a content provider, a content operator, a content viewer, etc.). For example, a user can select a region on a screen of a user device that includes a content element. Therefore, the tagging component 104 can implement auto-recognition to identify the particular content element in different scenes (e.g., different video frames, different time intervals, etc.) of the media item. In one embodiment, the tagging component 104 can associate a content element in the media item with a tag based on an image frame position or a time interval of the media item (e.g., without identifying placement of a content element in a media item). Therefore, the tagging component 104 can identify and/or assign one or more tags associated with one or more content elements for each image frame position or each time interval of the media item.

The matching component 106 can associate the tag with one or more other tags. For example, the matching component 106 can associate the tag with one or more other tags based at least in part on information associated with the tag. The matching component 106 can find (e.g., locate, etc.) the one or more other tags based at least in part on information associated with the tag. The one or more other tags can be associated with (e.g., located in) the media item and/or a different media item. For example, at least one of the one or more other tags can be associated with a first media item (e.g., a first video) and/or at least one of the one or more tags can be associated with a second media item (e.g., a second video).

The matching component 106 can be further configured to associate an image associated with the content element (e.g., a keyimage) with one or more other images (e.g., one or more other keyimages). For example, the matching component 106 can associate the keyimage with one or more other keyimages. The one or more other keyimages can be keyimages in the media item and/or a different media item. For example, at least one of the one or more other keyimages can be associated with a first media item (e.g., a first video) and/or at least one of the one or more keyimages can be associated with a second media item (e.g., a second video).

As such, the matching component 106 can determine one or more related tags (e.g., one or more similar tags) and/or one or more related images (e.g., one or more similar images) based at least in part on information associated with a tag. The information associated with a tag can include, but is not limited to, one or more keywords, detailed information, a description, a location of a tag within a media item (e.g., a timestamp), an image, purchase availability of a content element associated with a tag, one or more links to one or more information sources (e.g., a URL), etc. In one example, the matching component 106 can implement at least one matching criterion to determine one or more related tags (e.g., one or more similar tags) and/or one or more related images (e.g., one or more similar images). In one example, a matching criterion can be a keyword match between tags. For example, a tag can be associated with one or more keywords. Therefore, if a different tag includes one or more of the same keywords associated with the tag, the matching component 106 can associate the tag with the different tag. Additionally or alternatively, a matching criterion can be a keyword match between images. For example, an image can be associated with one or more keywords. Therefore, if a different image is associated with one or more of the same keywords associated with the image, the matching component 106 can associate the image with the different image. However, a matching criterion can be a different type of match, such as but not limited to, a detailed description match, a timestamp match, a media item match, a purchase availability match, a location match, etc.

For example, the matching component 106 can associate tags (and/or images) based on a content element associated with a person (or entity, object, product, good, device, etc.). For example, a content element associated with a person can include, but is not limited to, an actor, an actress, a director, a screenwriter, a sponsor of a media item, a content provider, etc. As such, tags (and/or images) associated with a common content element can be considered related tags (and/or related images). In one example, a matching criterion can be based on a media item. For example, the matching component 106 can associate tags (and/or images) that are in the same media item (e.g., in the same video). In another example, the matching component 106 can associate tags (and/or images) that are located in the same scene (e.g., chapter) of a media item (e.g., based on matching timestamp data). In one example, the matching component 106 can associate tags (and/or images) based on a geographic location. For example, tags (and/or images) associated with a particular geographic location can be associated. In another example, the matching component 106 can associate tags (and/or images) based on purchase availability and/or monetary payment.

In one embodiment, the matching component 106 can associate tags based on a group (e.g., a grouping of tags). For example, related (e.g., similar) tags can be determined based on one or more groups (e.g. groupings, categories, etc.). The matching component 106 can generate one or more groups. The matching component 106 can classify a tag with a particular group. A group can be associated with a particular matching criterion. For example, a group can be generated based on information associated with a tag. A tag can be associated with one or more groups (e.g., a tag can belong to one or more groups). As such, a tag can be associated with one or more other tags based on one or more groups (e.g., one or more matching criterion). Therefore, the matching component 106 can link (e.g., connect) a tag with one or more other tags.

Additionally or alternatively, the matching component 106 can associate images based on a group (e.g., a grouping of images). For example, related (e.g., similar) images can be determined based on one or more groups (e.g. groupings, categories, etc.). The matching component 106 can generate one or more groups. The matching component 106 can classify an image with a particular group. A group can be associated with a particular matching criterion. For example, a group can be generated based on information associated with an image. An image can be associated with one or more groups (e.g., an image can belong to one or more groups). As such, an image can be associated with one or more other images based on one or more groups (e.g., one or more matching criterion). Therefore, the matching component 106 can link (e.g., connect) an image with one or more other images.

In one embodiment, the matching component 106 can find one or more other tags associated with the tag based on image similarity and keyword data. For example, the matching component 106 can compare one or more keywords of a tag with one or more keywords of a different tag. In response to a determination that one or more keywords of the tag matches one or more keywords of the different tag, the matching component can then compare an image associated with the tag and a different image associated with the different tag. As such, the matching component 106 can be configured to verify a keyword match by additionally comparing images associated with tags.

In another embodiment, the matching component 106 can assign a relevancy score (e.g., a similarity score) to at least one other tag based on a comparison of the information (e.g., the information associated with the tag) with other information associated with the at least one other tag. For example, the matching component 106 can determine how relevant another tag is to the tag based on the information associated with the tag and other information associated the other tag. In one example, more matching criteria between tags can correlate to a higher relevancy score. Additionally or alternatively, the matching component 106 can generate a ranking of tags (e.g., a ranked list of tags) associated with the tag. For example, the matching component 106 can determine the ranking of tags based on the relevancy score (e.g., a higher relevancy score can correspond to a higher ranking). Additionally or alternatively, the matching component 106 can assign a relevancy score (e.g., a similarity score) to at least one other image based on a comparison of the information (e.g., the information associated with the image) with other information associated with the at least one other image. For example, the matching component 106 can determine how relevant another image is to the image based on the information associated with the image and other information associated the other image. In one example, more matching criteria between images can correlate to a higher relevancy score. Additionally or alternatively, the matching component 106 can generate a ranking of images (e.g., a ranked list of images) associated with the image. For example, the matching component 106 can determine the ranking of images based on the relevancy score (e.g., a higher relevancy score can correspond to a higher ranking).

Additionally or alternatively, the matching component can assign a relevancy score to at least one other media item. For example, the matching component 106 can determine how relevant a media item is to the tag (and/or the image). Relevancy can be determined, for example, based on the number of times the tag (and/or the image) is shown in a media item, content type associated with a media item, etc. Additionally or alternatively, the matching component 106 can generate a ranking of media items (e.g., a ranked list of media items) associated with the tag (and/or the image). For example, the matching component 106 can determine the ranking of media items based on a relevancy score (e.g., a higher relevancy score can correspond to a higher ranking).

In one embodiment, the matching component 106 can associate a tag and/or an image (e.g., a keyimage) with one or more other media items (e.g., one or more videos, etc.) and/or one or more sources of information (e.g., one or more website links, etc.). For example, the matching component 106 can be configured to identify (e.g., determine) additional media items associated with a tag and/or an image. For example, the matching component 106 can be configured to find additional media items associated with the tag and/or the image based at least in part on the information associated with a tag and/or an image.

In one non-limiting example, the tagging component 104 can assign a tag (and/or an image) to a product or good presented in a media item. For example, a tag (and/or an image) can be assigned to a soft drink presented in a video. The matching component 106 can associated the tag (e.g., the tag assigned to a soft drink) with one or more other tags (e.g., one or more other tags assigned to the soft drink). Additionally or alternatively, the matching component 106 can associate the image (e.g., the keyimage assigned to a soft drink) with one or more other images (e.g., one or more other keyimages assigned to the soft drink). For example, the tag (and/or the image) assigned to the soft drink in a first video can be associated with one or more other tags (and/or one or more other images) assigned to the soft drink in a second video (and/or a third video, a fourth video, etc.). As such, a user can be presented with one or more media items (e.g., one or more videos) that include the soft drink. Additionally or alternatively, a user can be presented with one or more other tags (and/or one or more other images) associated with the soft drink.

In another non-limiting example, the tagging component can assign a tag (and/or an image) to an actor (or actress). For example, a tag (and/or an image) can be assigned to a lead actor (or actress) in a movie. The matching component 106 can associate the tag (e.g., the tag associated with the actor) with one or more other tags (e.g., one or more other tags assigned to the actor). Additionally or alternatively, the matching component 106 can associate the image (e.g., the image associated with the actor) with one or more other images (e.g., one or more other images assigned to the actor). For example, the tag (and/or an image) can be grouped with other tags (and/or other images) assigned to the actor. As such, a user can be presented with one or more media items (e.g., one or more videos) starring the actor based at least in part on the grouping. Additionally or alternatively, a user can be presented with one or more other tags (and/or one or more other images) associated with the actor.

A data store 112 can store one or more tags, one or more images (e.g., keyimages) and/or associated information for content element(s). It should be appreciated that the data store 112 can be implemented external from the system 100 or internal to the system 100. It should also be appreciated that the data store 112 can be implemented external from the component 102. It should also be appreciated that the data store 112 can alternatively be internal to the tagging component 104 and/or the matching component 106. In an aspect, the data store 112 can be centralized, either remotely or locally cached, or distributed, potentially across multiple devices and/or schemas. Furthermore, the data store 112 can be embodied as substantially any type of memory, including but not limited to volatile or non-volatile, solid state, sequential access, structured access, random access and so on.

While FIG. 1 depicts separate components in system 100, it is to be appreciated that the components may be implemented in a common component. In one example, the tagging component 104 and the matching component 106 can be included in a single component. Further, it can be appreciated that the design of system 100 can include other component selections, component placements, etc., to associate tagged data for media content and/or media content images.

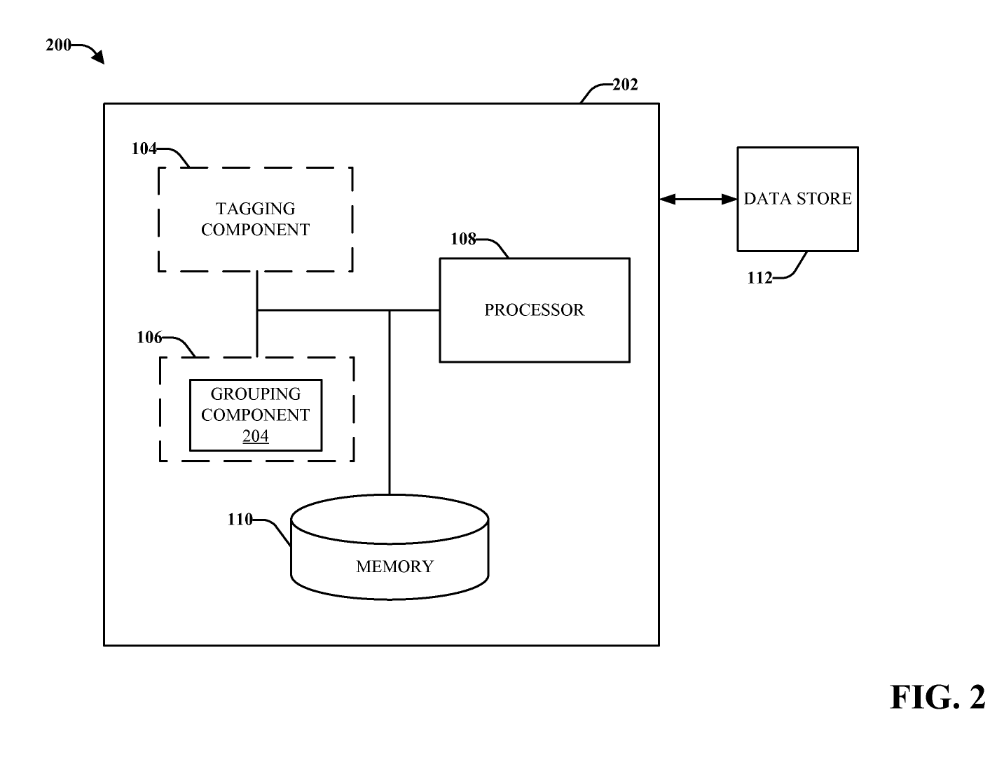

Referring to FIG. 2, there is illustrated a non-limiting implementation of a system 200 in accordance with various aspects and implementations of this disclosure. The system 200 includes a component 202. The component 202 includes the tagging component 104 and the matching component 106. The matching component 106 includes a grouping component 204.

The grouping component 204 can be configured to generate one or more groups. Furthermore, the grouping component 204 can be configured to add one or more tags and/or one or more images (e.g., a keyimage) to a group. As such, the grouping component 204 can be configured to group a tag with one or more other tags. Additionally or alternatively, the grouping component 204 can be configured to group an image (e.g., a keyimage associated with a tag and/or a content element) with one or more other images (e.g., one or more other keyimages).

As such, the grouping component 204 can be configured to associate one or more tags and/or one or more keyimages based on a grouping (e.g., a linking of tags and/or keyimages). For example, a tag can be assigned to a group based on information associated with a tag and/or a characteristic of the tag. One or more tags can be assigned to a group. As such, each tag in a group can be associated with other tags in the group. For example, one or more tags associated with an actor can be assigned to a group, one or more tags associated with a particular product or good can be assigned to a group, one or more tags associated with a content element that is available for purchase can be assigned to a group, one or more tags associated with a particular media item can be assigned to a group, etc. In one example, one or more tags associated with a particular scene, chapter or location depicted in a media item (e.g., a video) can be assigned to a group. As such, a tag can be assigned to a group based on, for example, a timestamp. Additionally or alternatively, a keyimage can be assigned to a group based on information associated with a keyimage and/or a characteristic of the keyimage. One or more keyimages can be assigned to a group. As such, each keyimage in a group can be associated with other keyimages in the group. For example, one or more keyimages associated with an actor can be assigned to a group, one or more keyimages associated with a particular product or good can be assigned to a group, one or more keyimages associated with a content element that is available for purchase can be assigned to a group, one or more keyimages associated with a particular media item can be assigned to a group, etc. In one example, one or more keyimages associated with a particular scene, chapter or location depicted in a media item (e.g., a video) can be assigned to a group. As such, a keyimage can be assigned to a group based on, for example, a timestamp.

The grouping component 204 can implement one or more groups to categorize tags and/or keyimages. As such, each tag in a group can be related based on a particular matching criterion. Additionally or alternatively, each keyimage in a group can be related based on a particular matching criterion. A matching criterion for a group can be associated with, but is not limited to, one or more keywords, other text, a detailed description, a category, metadata, a timestamp, other images, links, comments, ratings, purchase availability, coupons, discounts, advertisements, etc.

Additionally, the grouping component 204 can determine (e.g., find) similar tags and/or images based on the groupings. For example, each tag (and/or image) in a particular group can be considered related tags (and/or related images). As such, the grouping component 204 can find one or more tags related to a particular tag (e.g., in response to receiving a tag) based on the groupings. Additionally or alternatively, the grouping component 204 can find one or more images related to a particular image (e.g., in response to receiving a image) based on the groupings

In one embodiment, one or more tags can be identified via one or more keyimages. For example, one or more keyimages associated with one or more tags can be assigned to one or more groups. As such a group can include one or more related keyimages. In one example, keyimages can be displayed via a keyimage feed based on the groups. For example, keyimages (e.g., thumbnail images) of related keyimages can be grouped together under different categories (e.g., based on different criteria) to allow a user to easily search for and/or obtain different keyimages (e.g., tags for content elements).

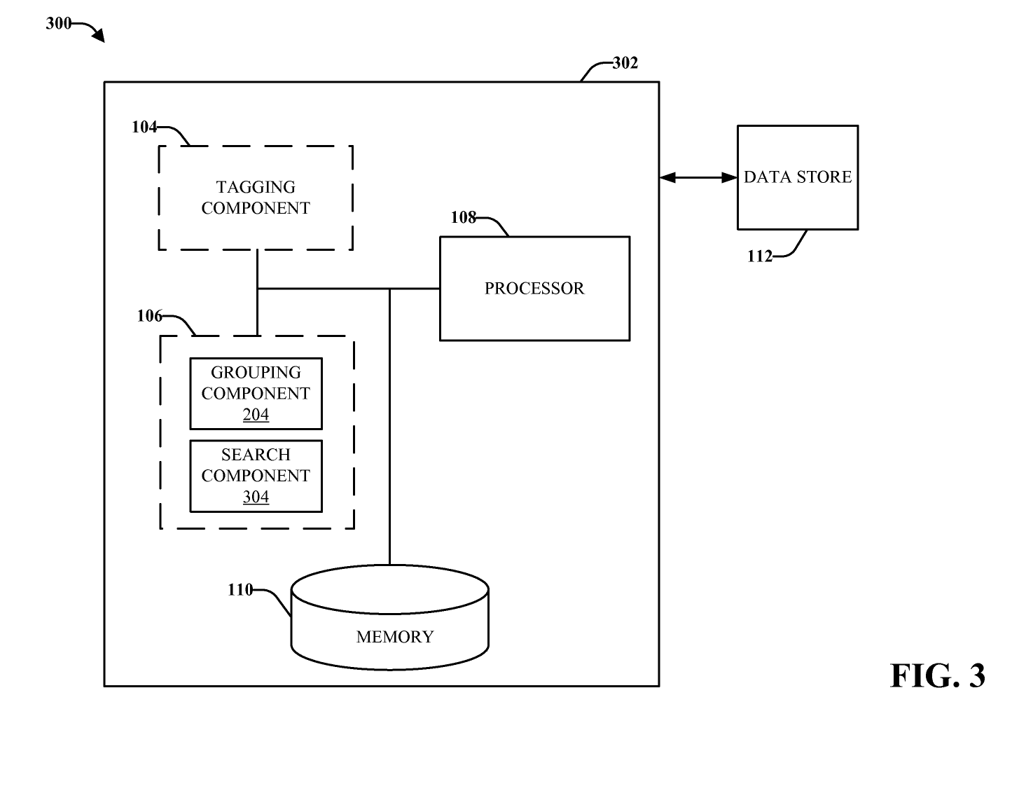

Referring to FIG. 3, there is illustrated a non-limiting implementation of a system 300 in accordance with various aspects and implementations of this disclosure. The system 300 includes a component 302. The component 302 includes the tagging component 104 and the matching component 106. The matching component 106 includes the grouping component 204 and a search component 304.

The search component 304 can be configured to identify (e.g., determine) additional media items associated with a tag and/or a keyimage. For example, the search component 304 can be configured to find additional media items associated with the tag and/or the keyimage based at least in part on the information associated with a tag. For example, the search component 304 can search for additional information not currently associated with a tag.

In one example, the search component 304 can find and/or associate one or more sources of information (e.g., a website, a link, etc.) with a tag and/or keyimage. In one embodiment, the search component 304 can provide the one or more source of information as search results. For example, the search component 304 can rank the one or more sources of information (e.g., provide search results) based on a determined reputation and/or determined relevancy of the one or more sources of information.

In one embodiment, the search component 304 can search for related information provided by one or more sources of information. For example, the search component 304 can match (e.g., associate) a tag and/or a keyimage with an image on a website. In one example, a tag and/or a keyimage associated with a product or good can be matched (e.g., associated) with an image of the product or good found on a website. As such, the search component 304 can add additional content to the information associated with the tag and/or keyimage (e.g., based on the search performed by the search component 304).

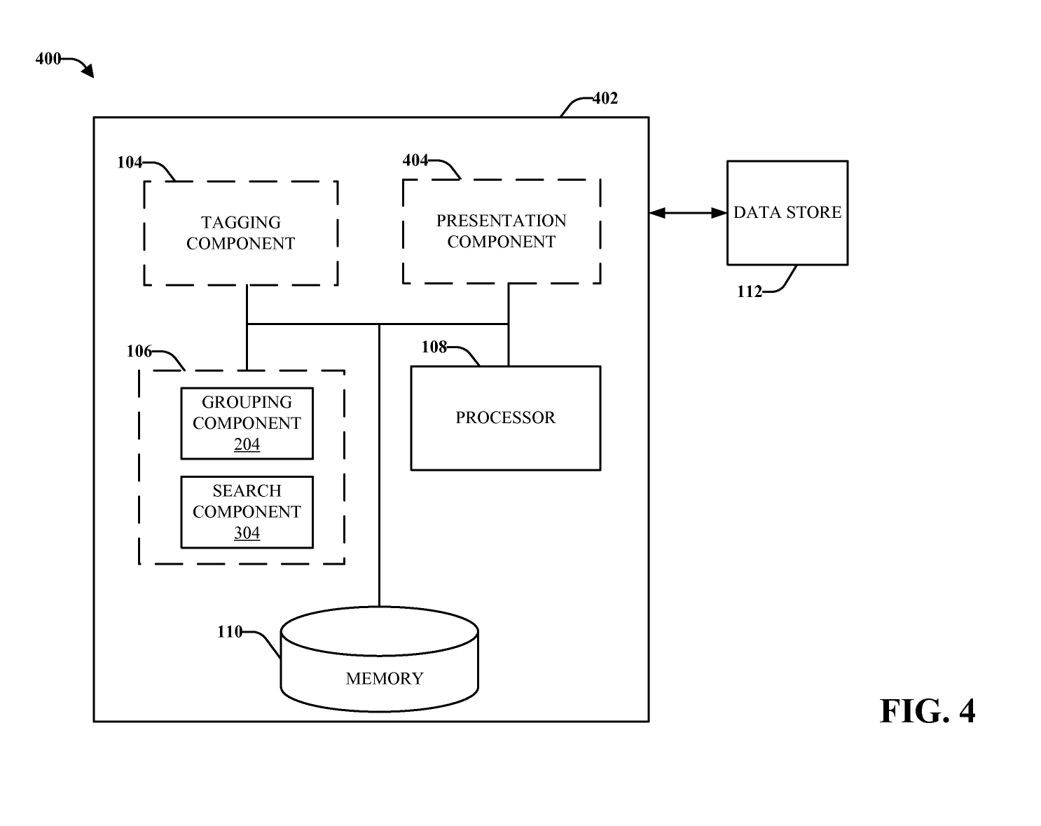

Referring to FIG. 4, there is illustrated a non-limiting implementation of a system 400 in accordance with various aspects and implementations of this disclosure. The system 400 includes a component 402. The component 402 includes the tagging component 104, the matching component 106 and a presentation component 404. The matching component 106 includes the grouping component 204 and the search component 304.

The presentation component 404 can present the tag and/or information regarding the content element. The presentation component 404 can present the tag and/or the information regarding the content element during playback of the media item. For example, the tag can be presented to a user device (e.g., a user device of a content consumer) during playback of the media item on the user device. The tag can be activated during playback of the media item on the user device. As such, information regarding the content element (e.g., information associated with the tag) can be presented on the user device.

In one example, the presentation component 404 can present a keyimage (e.g., a thumbnail image). The keyimage can be presented during playback of the media item and/or after playback of the media item. The keyimage can be presented on a user device that displays a media item and/or a different user device that does not display the media item.

In one embodiment, the presentation component 404 can sort groups of tags and/or groups of keyimages. For example, the presentation component 404 can sort groups of tags and/or groups of keyimages based on a score (e.g., each group can be assigned a score). In one example, the score can be determined based on relevancy. However, it is to be appreciated that a score can be determined based on different criteria. In one example, the presentation component 404 can determine a ranking of groups based on the score of each group.

The presentation component 404 can allow a user (e.g., a content consumer) to activate (e.g., click, push, etc.) a tag and/or keyimage for a content element. In one example, a tag (and/or an image) can be activated by clicking (or pushing) a content element associated with the tag (and/or the image) during playback of a media item. In another example, a tag can be activated by clicking on an item (e.g., a keyimage) associated with the tag during and/or after playback of a media item. For example, a thumbnail image (e.g., icon) can be activated during and/or after playback of a media item. The type of information presented to a user can depend on the information assigned to the content element. Additionally, the type of information presented to a user can depend on groupings of tags and/or keyimages. For example, related tags and/or keyimages can be grouped together (e.g., tags and/or keyimages can be categorized).

The presentation component 404 can provide one or more tags, one or more images (e.g., keyimages) and/or information to a user device (e.g., a playback device). For example, a user device (e.g., a playback device) can include a desktop computer, a laptop computer, an interactive television, an internet-connected television, a streaming media device, a smartphone, a tablet, a personal computer (PC), a gaming device, etc. In one example, the user device (e.g., the playback device) can be different than a device that displays the media item. For example, the user device (e.g., the playback device) can be a smartphone that displays one or more tags, one or more images (e.g., keyimages) and/or information corresponding to the one or more tags, and playback of the media item can be displayed on a television.

In one example, the presentation component 404 can present a tag to a user based on groupings. For example, thumbnails corresponding to a tag can be displayed based on groupings. As such, one or more thumbnails of related to one or more tag can be grouped together under different categories to allow a user to easily search for and/or obtain different tags presented in a video. In another example, the presentation component 404 can present a tag to a user based on an interest of a user. In yet another example, the presentation component 404 can present a tag to a user based on a previously searched tag. Therefore, the presentation component 404 can present a user with a subset of available tags based on user preferences. Additionally or alternatively, the presentation component 404 can present an image (e.g., a keyimage) to a user based on groupings. For example, one or more thumbnails corresponding to one or more images can be displayed based on groupings. As such, thumbnails of related images can be grouped together under different categories (e.g., different groups). In another example, the presentation component 404 can present an image to a user based on an interest of a user. In yet another example, the presentation component 404 can present an image (e.g., a keyimage) to a user based on a previously searched image (e.g., keyimage). Therefore, the presentation component 404 can present a user with a subset of available images (e.g., keyimages) based on user preferences.

In one embodiment, the presentation component 404 can present one or more prompts to a user device (e.g., a playback device) with one or more tags, one or more images and/or corresponding information associated with a particular tag and/or image. The presentation component 404 can be configured to present a prompt at a user device as a function of the display requirements of the user device and/or the configuration or layout of a screen with a media player for the media item. In an aspect, the presentation component 404 can be configured to determine the display requirements of a user device, such as screen size and/or configuration. In addition, in an aspect, the presentation component 404 can determine the layout and/or configuration of a screen with a media player for the media item. In another example, the presentation component 404 can be configured to determine areas on a screen of a user to device that can present one or more tags, one or more images and/or information associated with tags and/or images. In turn, the presentation component 404 can be configured to present a prompt with a size, shape, and/or orientation, which fits the display requirement of a user device and accommodate the size, shape, and/or configuration of tags and/or information associated with tags. For example, the presentation component 404 can display a prompt with one or more tags, one or more images and/or information associated with tags in an area associated with a blank space (e.g., an area that does not contain text and/or images) on a screen of a user device.

In one embodiment, the presentation component 404 can be configured to present a prompt and/or initiate an action (e.g., open a website) as a function of a content element associated with a tag and/or an image (e.g., a keyimage) being presented. For example, the presentation component 404 can be configured to present a prompt based on a content element associated with a tag and/or an image (e.g., a keyimage) being displayed during playback of a media item. In various aspects, the prompt can include, but is not limited to, a link to content associated with the tag and/or image (e.g., a URL link to a website for a content element associated with the tag and/or image), an advertisement, merchandise affiliated with the tag and/or image, etc. In one example, the prompt can be in the form of an interactive pop-up message (e.g., a pop-up dialogue box on a screen of a user device). In an aspect, the presentation component 404 can present a prompt (and/or initiate an action) after the passing of a predetermined amount of time after a content element associated with a tag and/or an image (e.g., a keyimage) is displayed. For example, the presentation component 404 can present the prompt (and/or initiate an action) fifteen seconds after a content element associated with a tag and/or an image (e.g., a keyimage) is displayed during playback of a media item.

The presentation component 404 can present the prompt on a screen of a user device that displays the media item. Additionally or alternatively, the presentation component 404 can present the prompt on a screen of a device that does not display the media item (e.g., a second device, a second screen, etc.). In one example, a content element (e.g., a watch) associated with a tag and/or an image (e.g., a keyimage) can be displayed while a user is viewing a media item (e.g., a video, a movie, etc.) on a user device (e.g., a television, a computer, etc.). Therefore, the user can receive a pop-up dialogue box on a screen of the user device with a prompt that includes a link to content associated with a tag and/or an image (e.g., a keyimage) for the content element (e.g., a URL link for a website associated with the watch). Additionally or alternatively, a website associated with the tag and/or an image (e.g., a keyimage) for the content element can be displayed on a screen of a second user device (e.g., a smartphone). For example, a website associated with the watch can be opened on a second user device of the user. As such, the presentation component 404 can present a prompt and/or initiate an action in response to a content element associated with a tag and/or an image (e.g., a keyimage) being displayed during playback of a media item.

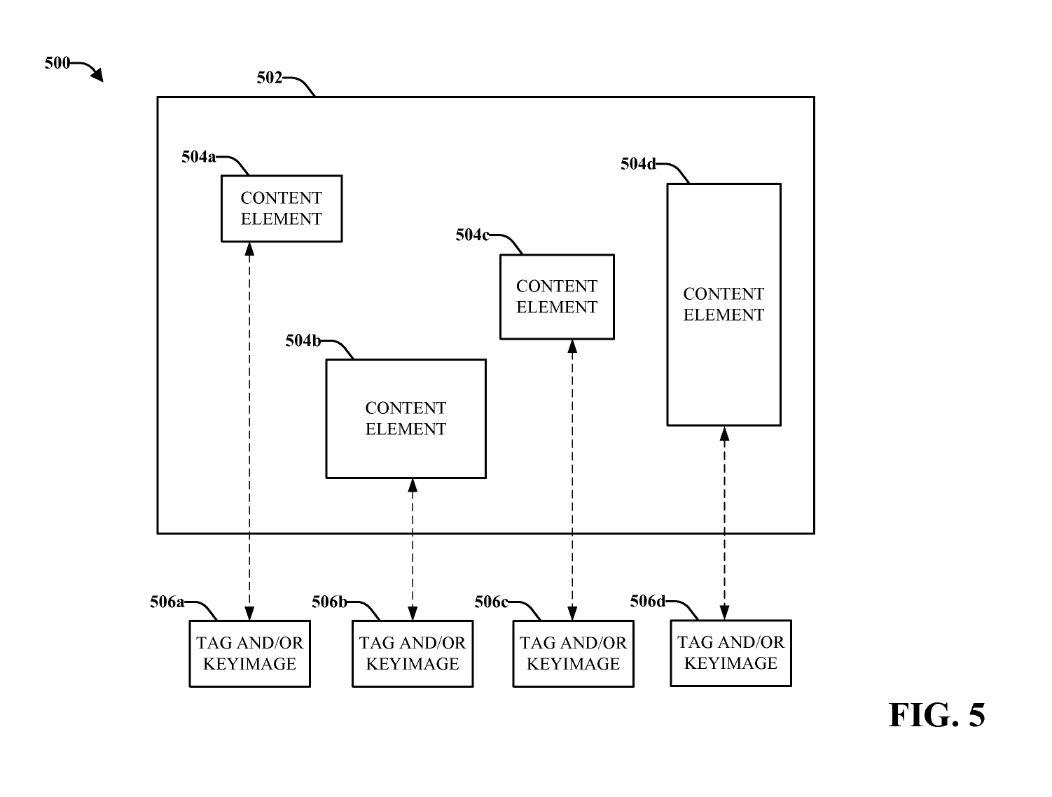

Referring now to FIG. 5, there is illustrated a non-limiting implementation of a system 500 in accordance with various aspects and implementations of this disclosure. The system 500 includes a media item 502. The media item 502 can include one or more content elements 504. In the example shown in FIG. 5, the media item 502 includes a content element 504a, a content element 504b, a content element 504c and a content element 504d. However, it is to be appreciated that a media item can include any number of content elements. The content elements 504a-d can each be assigned a tag and/or a keyimage. For example, the content element 504a can be assigned to a tag and/or keyimage 506a, the content element 504b can be assigned to a tag and/or keyimage 506b, the content element 504c can be assigned to a tag and/or keyimage 506c and the content element 504d can be assigned to a tag and/or keyimage 506d.

In a non-limiting example, the content element 504a can be a location, the content element 504b can be a product or good, the content element 504c can be a garment and the content element 504d can be an actor. As such, a tag (e.g., tag 506a) associated with the content element 504a (e.g., the location) can be, for example, a name of a city. Additionally or alternatively, a keyimage (e.g., keyimage 506a) associated with the content element 504a (e.g., the location) can be, for example, an image of a city. A tag (e.g., tag 506b) associated with the content element 504b (e.g., the product or good) can be, for example, a name of the product or good. Additionally or alternatively, a keyimage (e.g., keyimage 506b) associated with the content element 504b (e.g., the product or good) can be, for example, an image of the product or good. A tag (e.g., tag 506c) associated with the content element 504c (e.g., the garment) can be, for example, a name of the garment. Additionally or alternatively, a keyimage (e.g., keyimage 506c) associated with the content element 504c (e.g., the garment) can be, for example, an image of the garment. A tag (e.g., tag 506d) associated with the content element 504d (e.g., the actor) can be, for example, a name of the actor. Additionally or alternatively, a keyimage (e.g., keyimage 506d) associated with the content element 504d (e.g., the actor) can be, for example, an image of the actor. In one example, a keyimage can be a thumbnail image of a content element as shown on the screen 502. For example, the keyimage 506b associated with the content element 504b (e.g., a product or good) can be a thumbnail image of the content element 504b (e.g., the product or good) as displayed via the display 502.

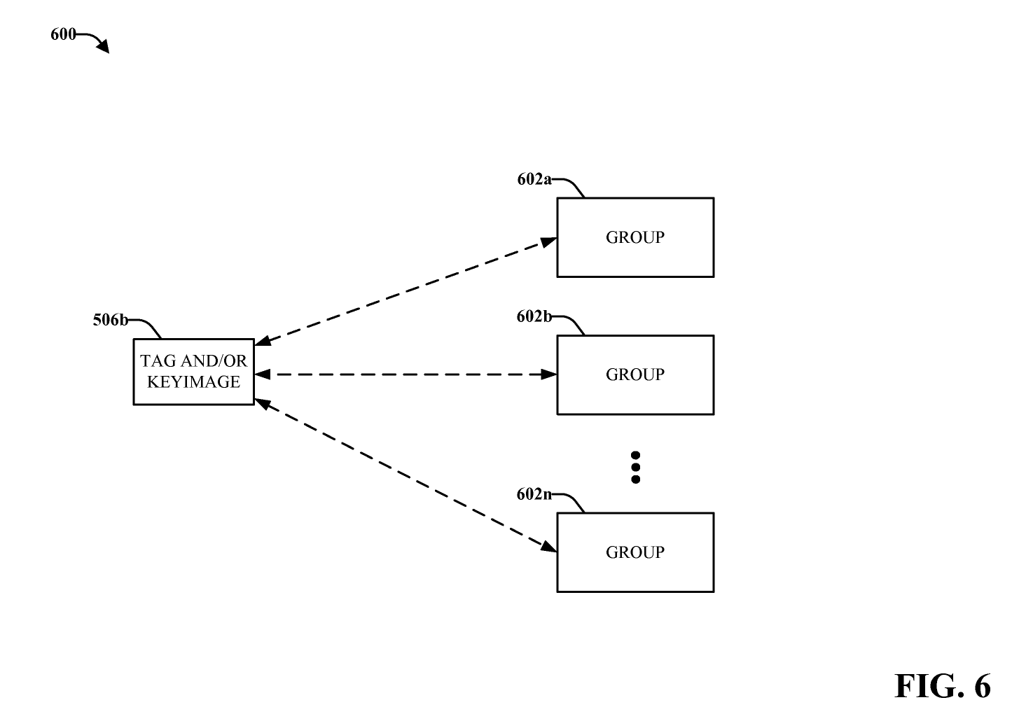

Referring now to FIG. 6, there is illustrated a non-limiting implementation of a system 600 in accordance with various aspects and implementations of this disclosure. The system 600 includes the tag and/or keyimage 506b and one or more groups 602a-n. The tag and/or keyimage 506b can be associated with the groups 602a-n. For example, the tag and/or keyimage 506b can be associated with a product or good. Therefore, in one example, the group 602a can be a group that includes one or more tags associated with a media item (e.g., a media item associated with tag 506b), the group 602b can be a group that includes one or more tags for the product or good, and the group 602n can be a group that includes one or more tags for a product or good that is available to be purchased. Additionally or alternatively, in one example, the group 602a can be a group that includes one or more keyimages associated with a media item (e.g., a media item associated with keyimage 506b), the group 602b can be a group that includes one or more keyimages for the product or good, and the group 602n can be a group that includes one or more keyimages for a product or good that is available to be purchased. As such, the tag and/or keyimage 506b can be included in (e.g., associated with) one or more groups. Furthermore, each of the groups 602a-n can categorize tags (e.g., tag 506b) based on different criterion. Additionally or alternatively, each of the groups can categorize keyimages (e.g., keyimage 506b) based on different criteria.

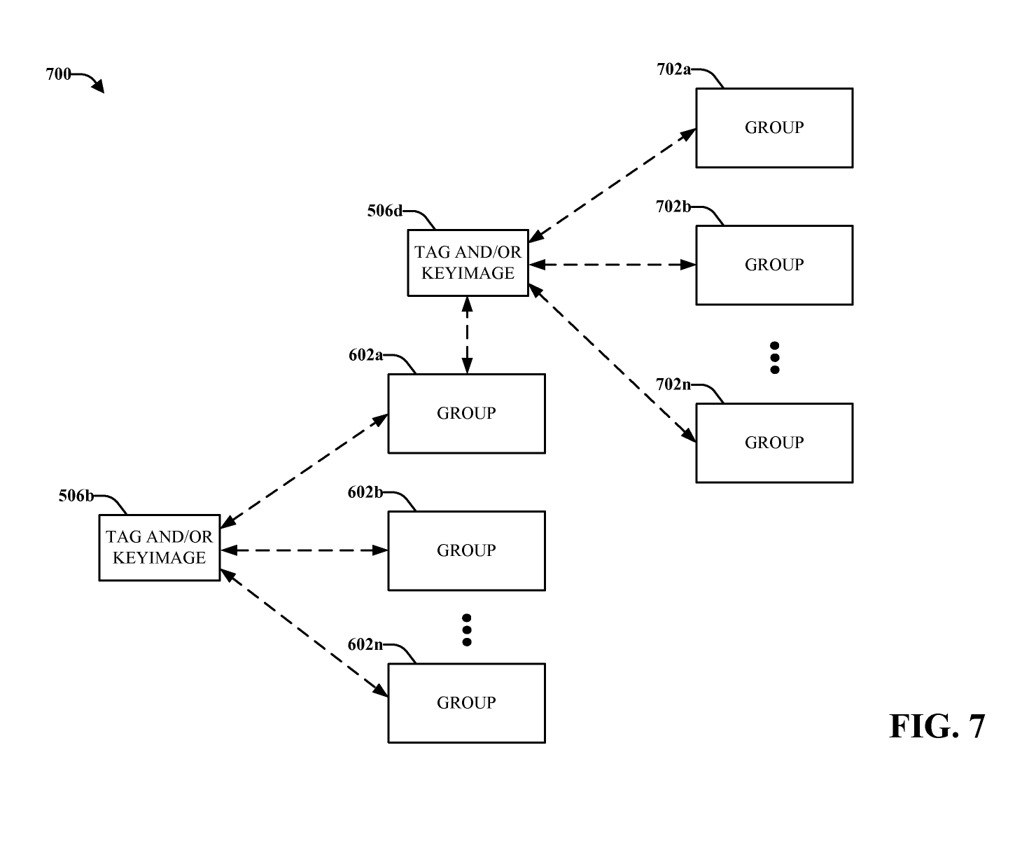

Referring now to FIG. 7, there is illustrated a non-limiting implementation of a system 700 in accordance with various aspects and implementations of this disclosure. The system 700 includes the tag and/or keyimage 506b, the tag and/or keyimage 506d, one or more groups 602a-n and one or more groups 702a-n. The tag and/or keyimage 506b can be associated with the groups 602a-n. For example, the tag and/or keyimage 506b can be associated with a product or good. Therefore, in one example, the group 602a can be a group that includes one or more tags associated with a media item (e.g., a media item associated with the tag 506b), the group 602b can be a group that includes one or more tags for the product or good, and the group 602n can be a group that includes one or more tags for a product or good that is available to be purchased. Additionally or alternatively, in one example, the group 602a can be a group that includes one or more keyimages associated with a media item (e.g., a media item associated with keyimage 506b), the group 602b can be a group that includes one or more keyimages for the product or good, and the group 602n can be a group that includes one or more keyimages for a product or good that is available to be purchased. As such, the tag and/or keyimage 506b can be included in (e.g., associated with) one or more groups.

Additionally, the tag and/or keyimage 506d can be associated with the groups 702a-n and the group 602a. Therefore, the tag and/or keyimage 506b and the tag and/or keyimage 506d can both be included in the group 602a. For example, the tag and/or keyimage 506d can be associated with an actor. As such, in one example, the group 602a can be a group that includes one or more tags associated with a media item (e.g., tag 506b and tag 506d can both be included in the same media item). Additionally or alternatively, in one example, the group 602a can be a group that includes one or more keyimages associated with a media item (e.g., keyimage 506b and keyimage 506d can both be included in the same media item). In one example, the group 702a can be a group that includes one or more tags and/or one or more keyimages associated with the actor, the group 702b can be a group associated with a media item that includes the actor (e.g., a movie starring the actor), and the group 702n can be a group associated with a particular award (e.g., an award that the actor won).

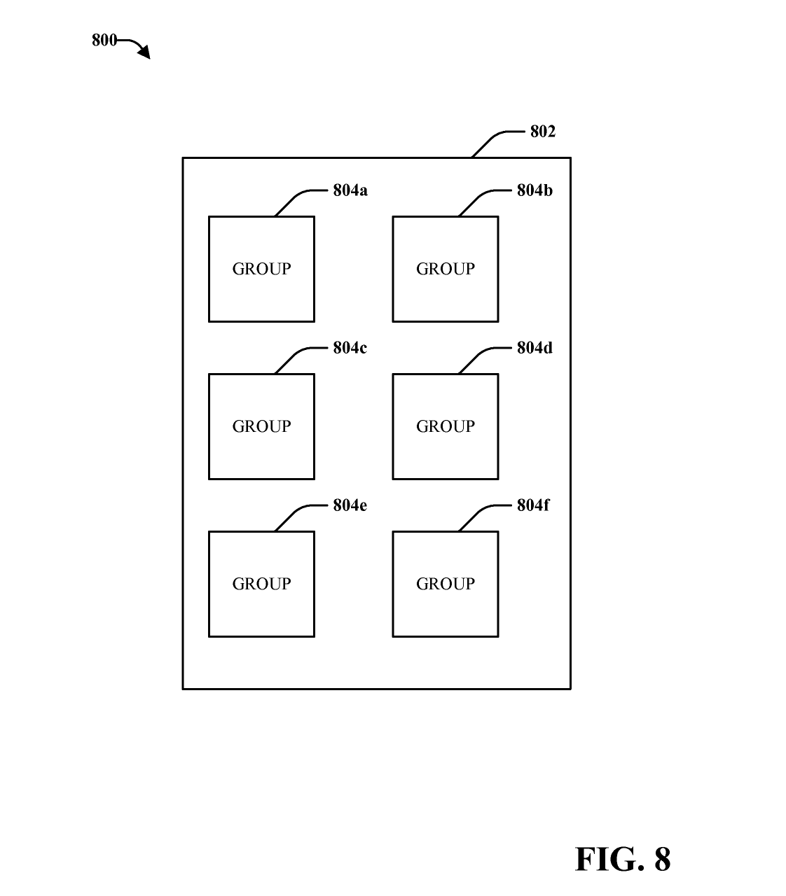

Referring to FIG. 8, there is illustrated a non-limiting implementation of a system 800 in accordance with various aspects and implementations of this disclosure. The system 800 includes a display 802 and groups 804a-f. The groups 804a-f can be implemented as icons (e.g., buttons, etc.). In one example, each of the groups 804a-f can include one or more associated tags. In another example, each of the groups 804a-f can include one or more keyimages (e.g., one or more thumbnail images). Each of the groups 804a-f can be associated with a different matching criterion. For example, the groups 804a-f can be determined based on information associated with tags.

In one embodiment, the groups 804a-f can be sorted (e.g., ranked) based on a score. For example, each of the groups 804a-f can be assigned a score. As such, a group with a highest score can be listed first, a group with a second highest score can be listed second, etc. In one example, a score can be determined based on relevancy. For example, a particular group more relevant to a user (e.g., based on a user preference, interest and/or search history) can be listed higher.

In one embodiment, the groups 804a-f can be presented based on a user interest level. As such, in one example, the groups 804a-f can be a subset of available tags (e.g., a subset of available tags determined to be relevant to a user can be presented to the user).

The groups 804a-f can be presented on one or more user devices (e.g., one or more client devices, one or more playback devices, etc.). In one example, the groups 804a-f can be presented in connection with a media service. A user device can include any computing device generally associated with a user and capable of playing a media item and interacting with media content (e.g., a video, a media service, etc.). For example, a user device can include a desktop computer, a laptop computer, an interactive television, a smartphone, a gaming device, or a tablet personal computer (PC). As used herein, the term user refers to a person, entity, or system that utilizes a user device and/or utilizes media content (e.g., employs a media service). The groups 804a-f can be activated during playback of a media item (e.g., by clicking on an icon associated with a particular one of the groups 804a-f). In one example, the groups 804a-f can be presented, for example, on a prompt associated with a media item. In one embodiment, a user device is configured to access a media service via a network such as the Internet or an intranet. In another embodiment, a media service is integral to a user device. For example, a user device can include a media service.

In an aspect, a user device interfaces with media service via an interactive web page. For example a page, such as a hypertext mark-up language (HTML) page, can be displayed at a user device and is programmed to be responsive to a the playing of a media item at the user device. It is noted that although the embodiments and examples will be illustrated with respect to an architecture employing HTML pages and the World Wide Web, the embodiments and examples may be practiced or otherwise implemented with any network architecture utilizing clients and servers, and with distributed architectures, such as but not limited to peer to peer systems.

In an embodiment, the media service can include an entity such as a world wide web, or Internet, website configured to provide media items. According to this embodiment, a user can employ a user device to view or play a media item as it is streaming from the cloud over a network from the media service. For example, media service can include a streaming media provider, or a website affiliated with a broadcasting network. In another embodiment, media service can be affiliated with a media provider, such as an Internet media provider or a television broadcasting network. According to this embodiment, the media provider can provide media items to a user device and employ media service to present prompts to the user device associated with the media items. Still in yet another embodiment, a user device can include a media service to monitor media items received from external sources or stored and played locally at the user device.

In one example, the screen 802 can be implemented on a user device that plays the media content associated with the one or more groups 804a-f. For example, during playback of media content, the one or more groups 804a-f can be activated. In one example, the one or more groups 804a-f can be displayed along side a video player that plays the media content. In one embodiment, the screen 802 can be implemented as a second screen. For example, a video player that plays the media content can be implemented on a first user device (e.g., a television) and the one or more groups 804a-f can be activated via a second user device (e.g., a smartphone). In one example, placement of the one or more groups 804a-f (e.g., presentation of the one or more groups 804a-f) can be determined by a ranking of the groups 804a-f.

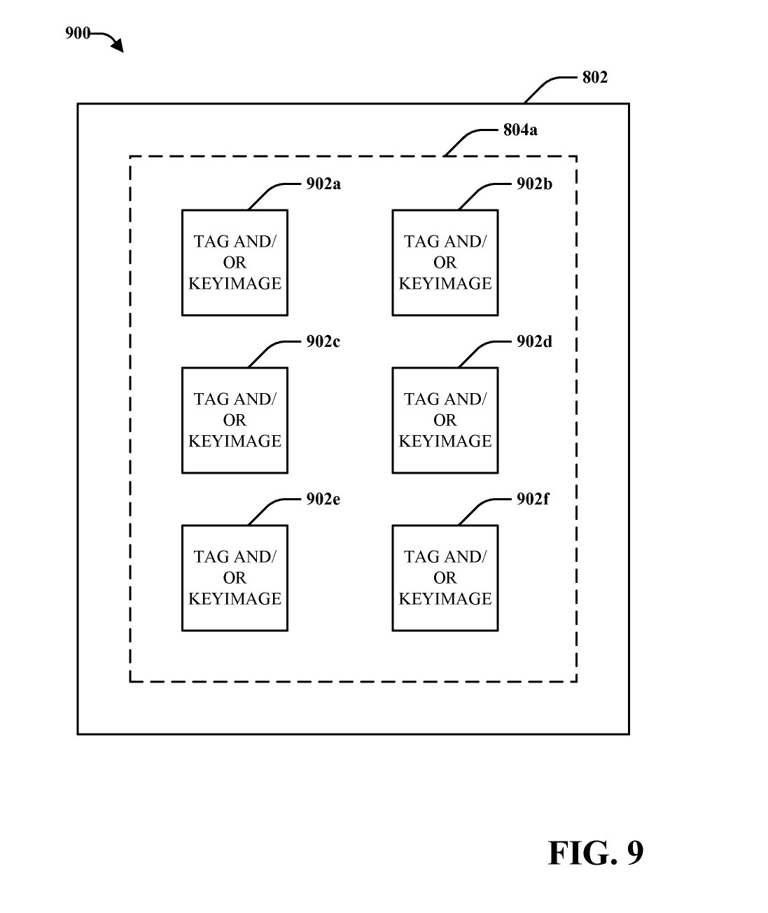

Referring to FIG. 9, there is illustrated a non-limiting implementation of a system 900 in accordance with various aspects and implementations of this disclosure. The system 900 includes the display 802 and the group 804a. The group 804a includes tags and/or keyimages 902a-f. For example, the group 804a can include tags 902a-f. Additionally or alternatively, the group can include keyimages 902a-f. In one example, each of the tags and/or keyimages 902a-f can be represented by a thumbnail (e.g. an icon). For example, a thumbnail can include a picture of a corresponding content element (e.g., as displayed in a media item). Additionally or alternatively, each of the tags and/or keyimages 902a-f can be represented by a keyword (e.g., a keyword associated with a tag).

In one embodiment, the tags and/or keyimages 902a-f can be sorted (e.g., ranked) based on a score. For example, each of the tags and/or keyimages 902a-f can be assigned a score. As such, a tag (e.g., tag 902a) with a highest score can be listed first, a tag (e.g., tag 902b) with a second highest score can be listed second, etc. In one example, a score can be determined based on relevancy. Additionally or alternatively, a keyimage (e.g., keyimage 902a) with a highest score can be listed first, a keyimage (e.g., keyimage 902b) with a second highest score can be listed second, etc. In one example, a score can be determined based on relevancy. In one embodiment, the tags and/or keyimages 902a-f can be presented based on a user interest level. As such, in one example, the tags and/or keyimages 902a-f can be a subset of available tags and/or keyimages.

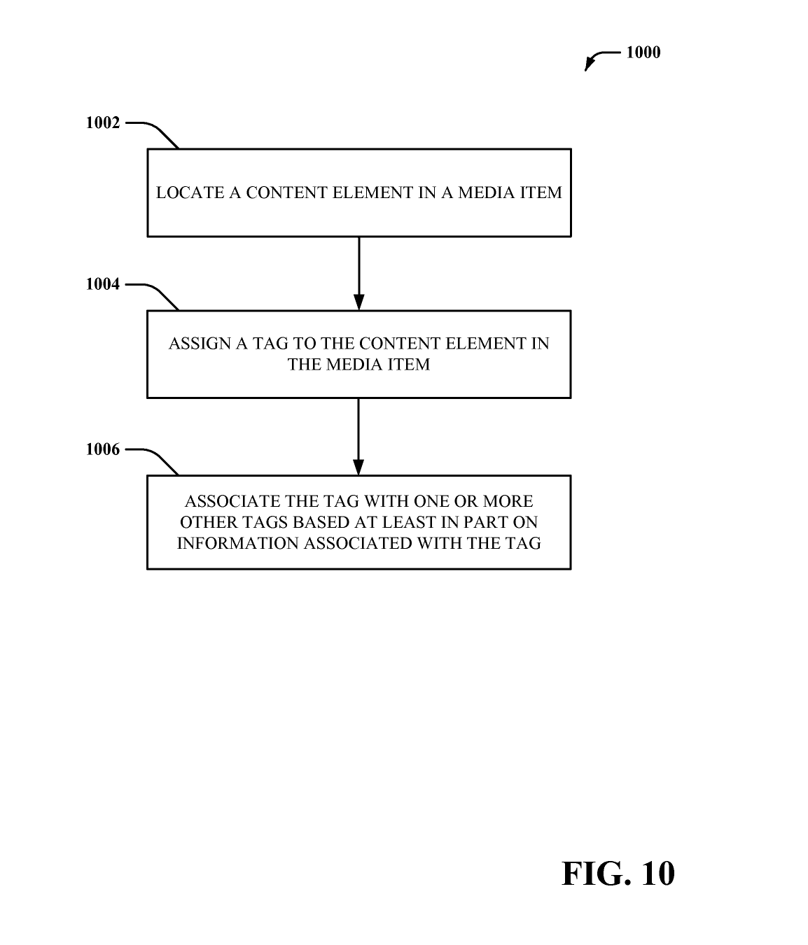

FIGS. 10-16 illustrate various methodologies in accordance with the disclosed subject matter. While, for purposes of simplicity of explanation, the methodologies are shown and described as a series of acts, it is to be understood and appreciated that the disclosed subject matter is not limited by the order of acts, as some acts may occur in different orders and/or concurrently with other acts from that shown and described herein. For example, those skilled in the art will understand and appreciate that a methodology can alternatively be represented as a series of interrelated states or events, such as in a state diagram. Moreover, not all illustrated acts may be required to implement a methodology in accordance with the disclosed subject matter. Additionally, it is to be further appreciated that the methodologies disclosed hereinafter and throughout this disclosure are capable of being stored on an article of manufacture to facilitate transporting and transferring such methodologies to computers.

Referring now to FIG. 10, presented is an exemplary non-limiting embodiment of a method 1000 for associating tagged data in media content. At 1002, a content element is located in a media item. For example, an object, a product, a good, a device, an item of manufacture, a person, an entity, a geographic location or a place can be found in a media item (e.g., a movie, a live television program, a recorded television program, a streaming video clip, a user-generated video clip, etc.). At 1004, a tag is assigned to the content element in the media item. For example, a tag can be assigned to an object, a product, a good, a device, an item of manufacture, a person, an entity, a geographic location or a place in a media item (e.g., a movie, a live television program, a recorded television program, a streaming video clip, a user-generated video clip, etc.). At 1006, the tag is associated with one or more other tags based at least in part on information associated with the tag. For example, the tag can be associated with one or more other tags in the media item and/or one or more other tags in a different media item based at least in part on information associated with the tag. The information can include, but is not limited to, one or more keywords, a categorization, a description, other text, metadata, a timestamp, an opportunity to purchase, geographic location, etc.

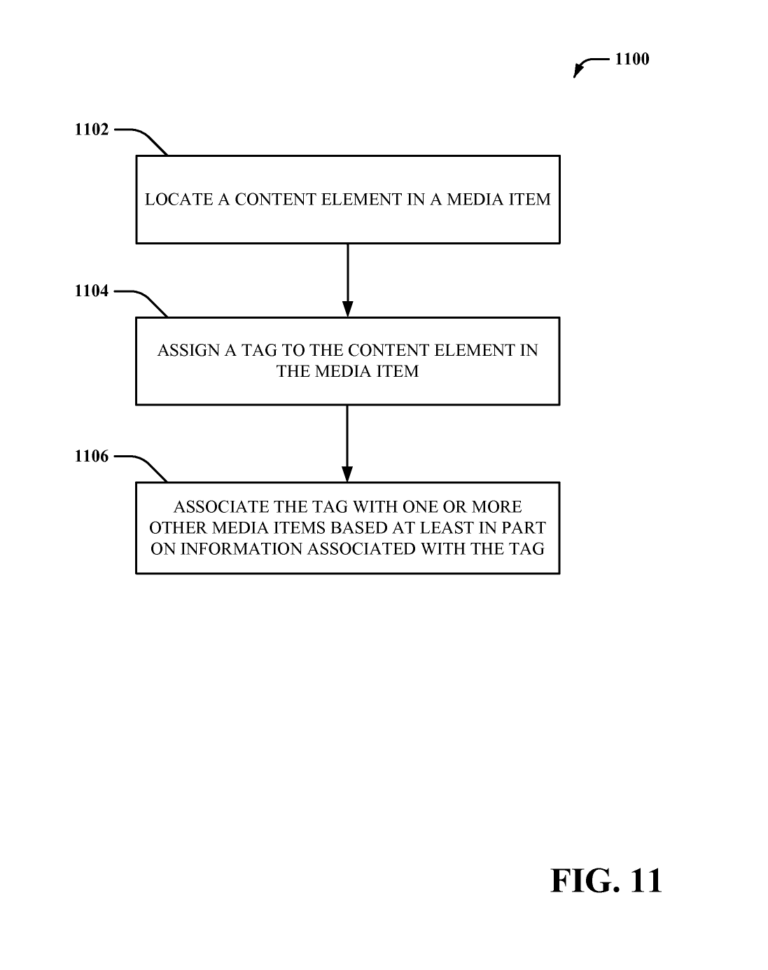

Referring now to FIG. 11, presented is another exemplary non-limiting embodiment of a method 1100 for associating tagged data in media content. At 1102, a content element is located in a media item. For example, an object, a product, a good, a device, an item of manufacture, a person, an entity, a geographic location or a place can be found in a media item (e.g., a movie, a live television program, a recorded television program, a streaming video clip, a user-generated video clip, etc.). At 1104, a tag is assigned to the content element in the media item. For example, a tag can be assigned to an object, a product, a good, a device, an item of manufacture, a person, an entity, a geographic location or a place in a media item (e.g., a movie, a live television program, a recorded television program, a streaming video clip, a user-generated video clip, etc.). At 1106, the tag is associated with one or more other media items based at least in part on information associated with the tag. For example, the tag can be associated with one or more other videos (e.g., movies, live television programs, recorded television programs, streaming video clips, user-generated video clips, etc.). The information can include, but is not limited to, one or more keywords, a categorization, a description, other text, metadata, a timestamp, an opportunity to purchase, geographic location, etc.

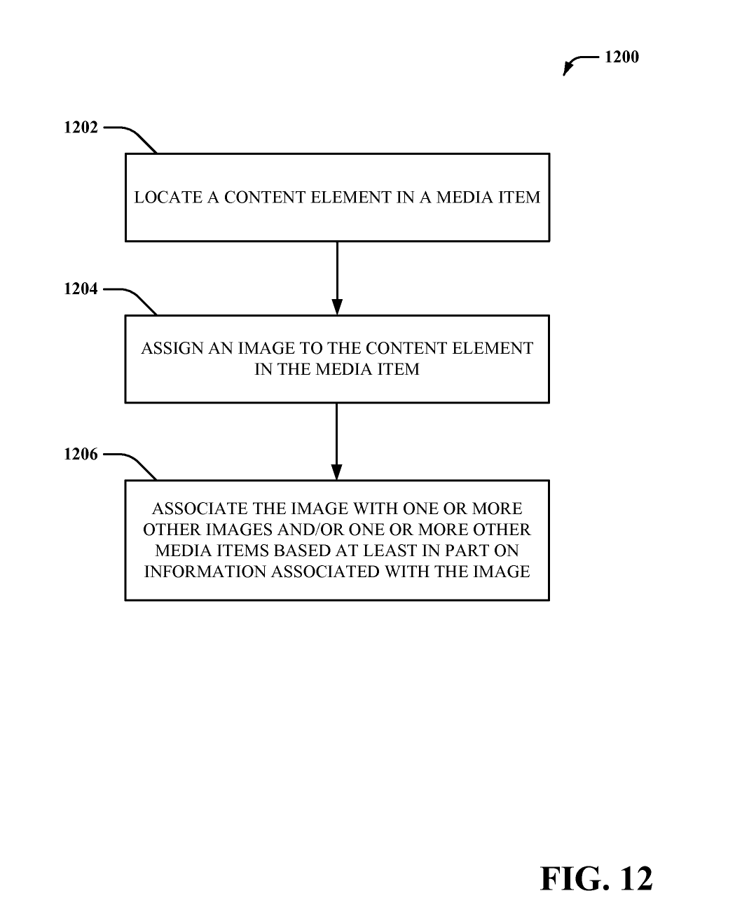

Referring now to FIG. 12, presented is an exemplary non-limiting embodiment of a method 1200 for associating media content images. At 1202, a content element is located in a media item. For example, an object, a product, a good, a device, an item of manufacture, a person, an entity, a geographic location or a place can be found in a media item (e.g., a movie, a live television program, a recorded television program, a streaming video clip, a user-generated video clip, etc.). At 1204, an image is assigned to the content element in the media item. For example, an image can be assigned to an object, a product, a good, a device, an item of manufacture, a person, an entity, a geographic location or a place in a media item (e.g., a movie, a live television program, a recorded television program, a streaming video clip, a user-generated video clip, etc.). At 1206, the image is associated with one or more other images and/or one or more other media items based at least in part on information associated with the image. For example, the image can be associated with one or more other images associated with the media item and/or one or more other images associated with a different media item based at least in part on information associated with the image. Additionally or alternatively, the image can be associated with one or more other videos (e.g., movies, live television programs, recorded television programs, streaming video clips, user-generated video clips, etc.). The information can include, but is not limited to, one or more keywords, a categorization, a description, other text, metadata, a timestamp, an opportunity to purchase, geographic location, etc.

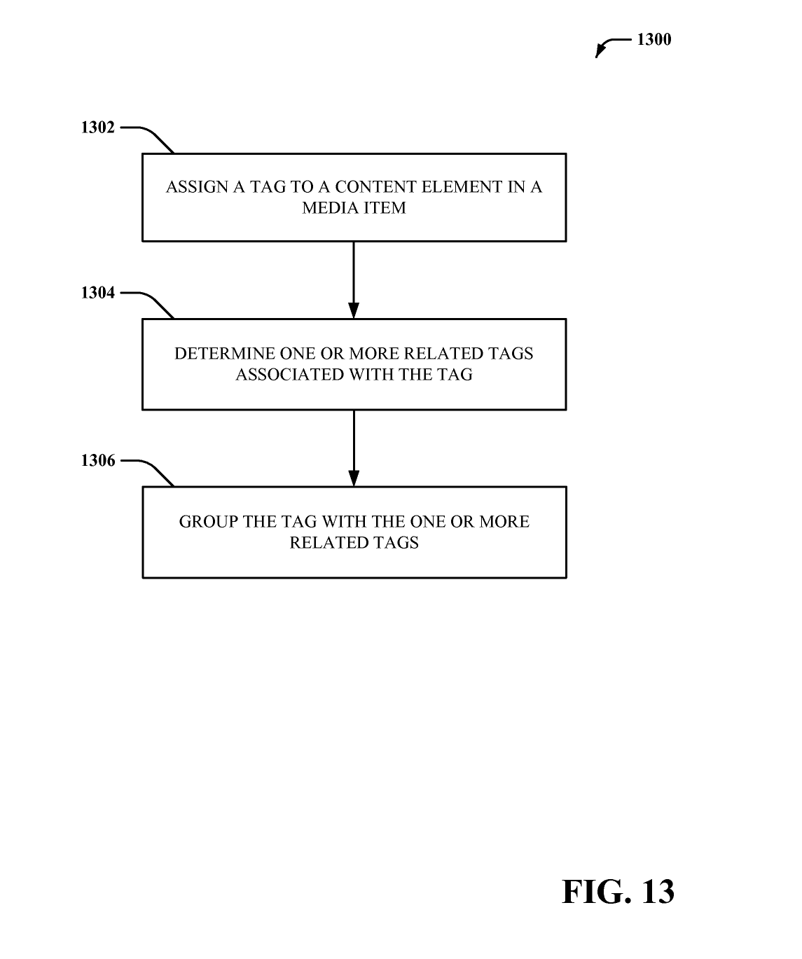

Referring now to FIG. 13, presented is an exemplary non-limiting embodiment of a method 1300 for grouping tagged data in media content. At 1302, a tag is assigned to a content element in a media item. For example, a tag can be assigned to an object, a product, a good, a device, an item of manufacture, a person, an entity, a geographic location or a place in a media item (e.g., a movie, a live television program, a recorded television program, a streaming video clip, a user-generated video clip, etc.). At 1304, one or more related tags associated with the tag are determined. For example, one or more related tags in the media item and/or one or more related tags in a different media can be determined. At 1306, the tag is grouped with the one or more related tags. For example, the tag can be associated with the one or more related tags by grouping the tag together with the one or more related tags.

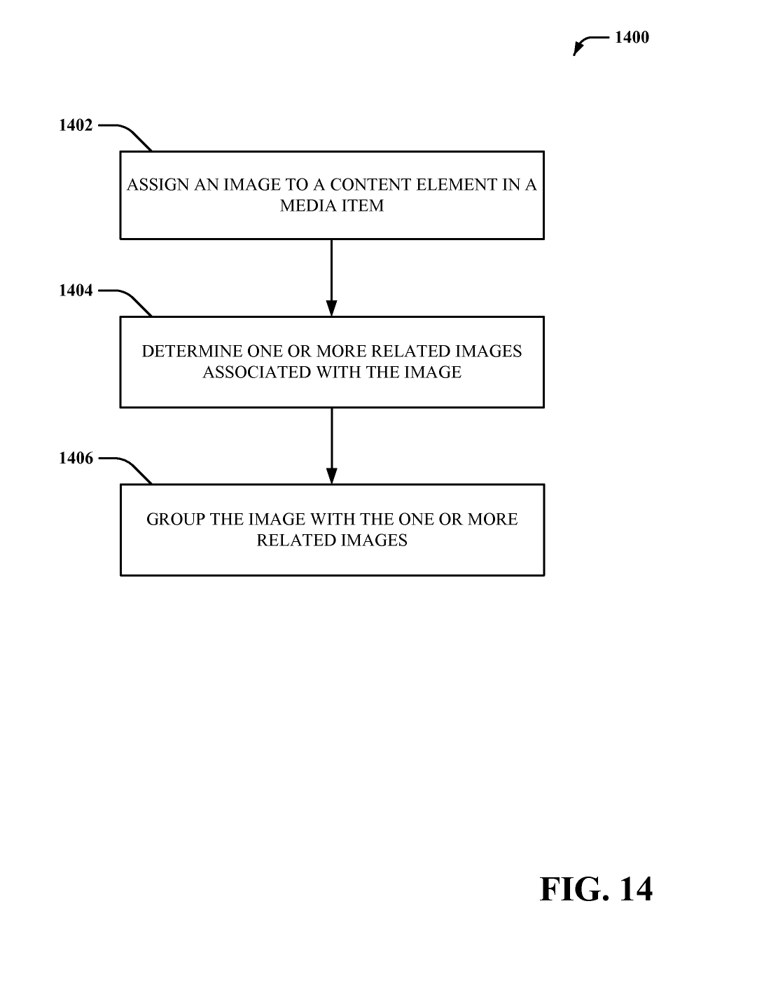

Referring now to FIG. 14, presented is another exemplary non-limiting embodiment of a method 1400 for grouping tagged data in media content. At 1402, an image is assigned to a content element in a media item. For example, an image can be assigned to an object, a product, a good, a device, an item of manufacture, a person, an entity, a geographic location or a place in a media item (e.g., a movie, a live television program, a recorded television program, a streaming video clip, a user-generated video clip, etc.). At 1404, one or more related images associated with the images are determined. For example, one or more related images associated with the media item and/or one or more related images associated with a different media can be determined. At 1406, the image is grouped with the one or more related images. For example, the image can be associated with the one or more related images by grouping the image together with the one or more related images.

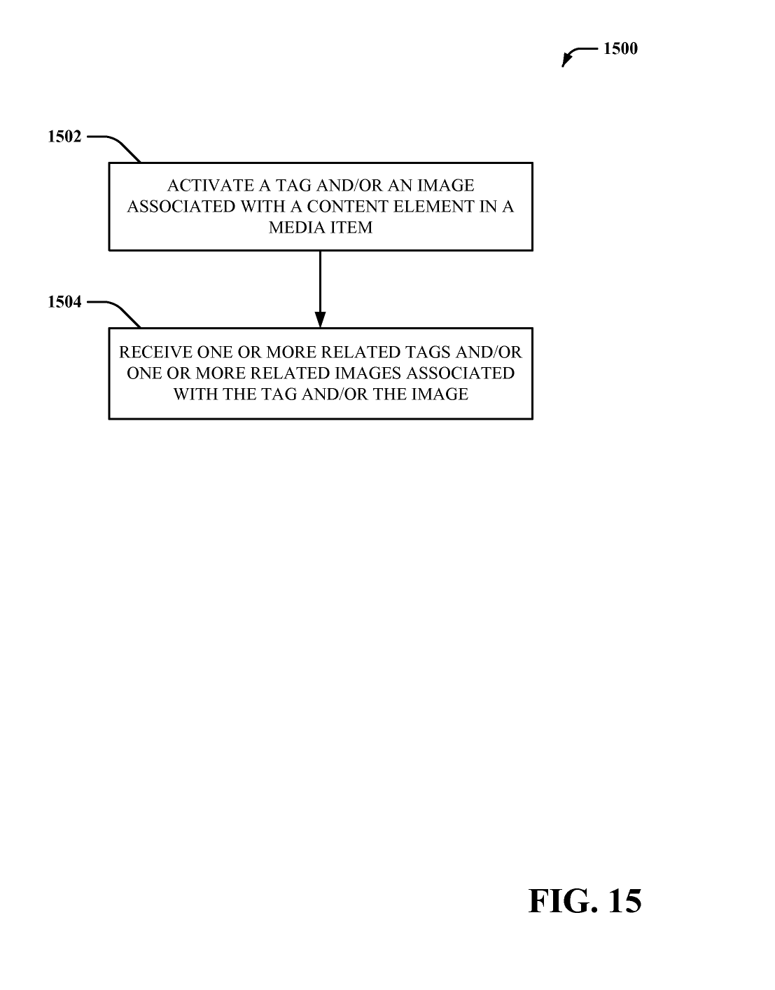

Referring now to FIG. 15, presented is an exemplary non-limiting embodiment of a method 1500 for receiving tagged data in media content. At 1502, a tag and/or an image associated with a content element in a media item is activated. For example, a tag and/or an image assigned to an object, a product, a good, a device, an item of manufacture, a person, an entity, a geographic location or a place in a media item (e.g., a movie, a live television program, a recorded television program, a streaming video clip, a user-generated video clip, etc.) can be activated (e.g., clicked, pushed, etc.). At 1504, one or more related tags and/or one or more related images associated with the tag and/or the image are received. For example, one or more related tags in the media item and/or one or more related tags in a different media can be presented to a user. Additionally or alternatively, one or more related images associated with the media item and/or one or more related images associated with a different media can be presented to a user

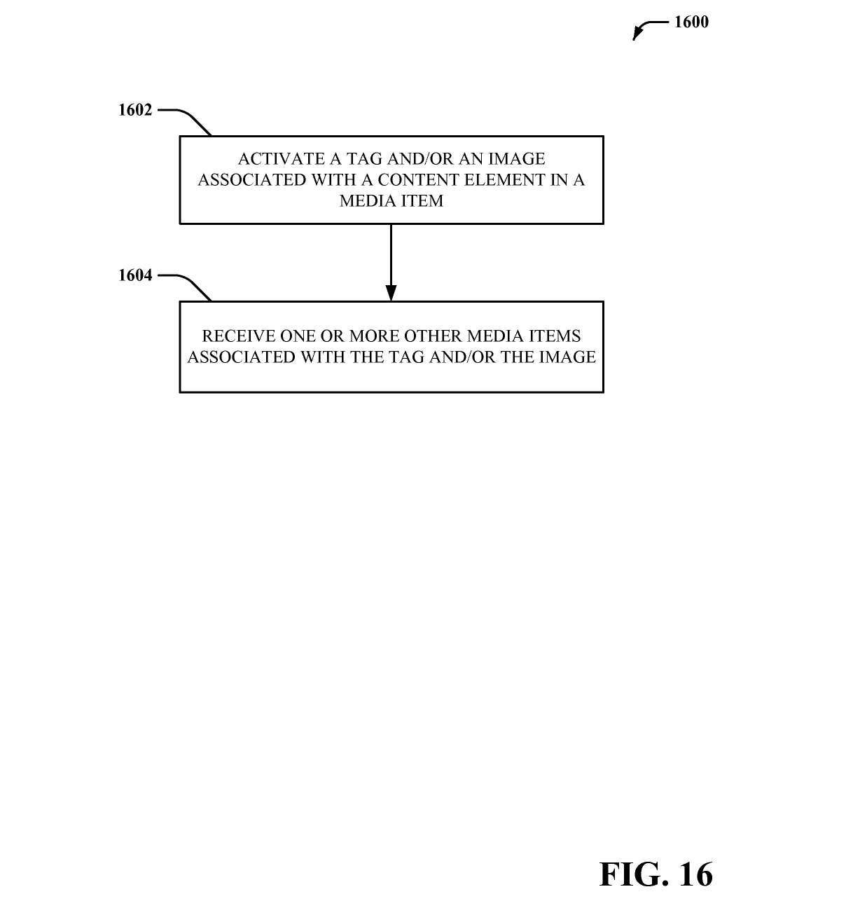

Referring now to FIG. 16, presented is another exemplary non-limiting embodiment of a method 1600 for receiving tagged data in media content. At 1602, a tag and/or an image associated with a content element in a media item is activated. For example, a tag and/or an image assigned to an object, a product, a good, a device, an item of manufacture, a person, an entity, a geographic location or a place in a media item (e.g., a movie, a live television program, a recorded television program, a streaming video clip, a user-generated video clip, etc.) can be activated (e.g., clicked, pushed, etc.). At 1604, one or more related media items associated with the tag and/or the image are received. For example, one or more related videos (e.g., movies, live television programs, recorded television programs, streaming video clips, user-generated video clips, etc.) can be presented to a user.

### Example Operating Environments

One of ordinary skill in the art can appreciate that the various non-limiting embodiments of matrix generation and matrix utilization and methods described herein can be implemented in connection with any computer or other client or server device, which can be deployed as part of a computer network or in a distributed computing environment, and can be connected to any kind of data store. In this regard, the various non-limiting embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the matrix generation and matrix utilization as described for various non-limiting embodiments of the subject disclosure.

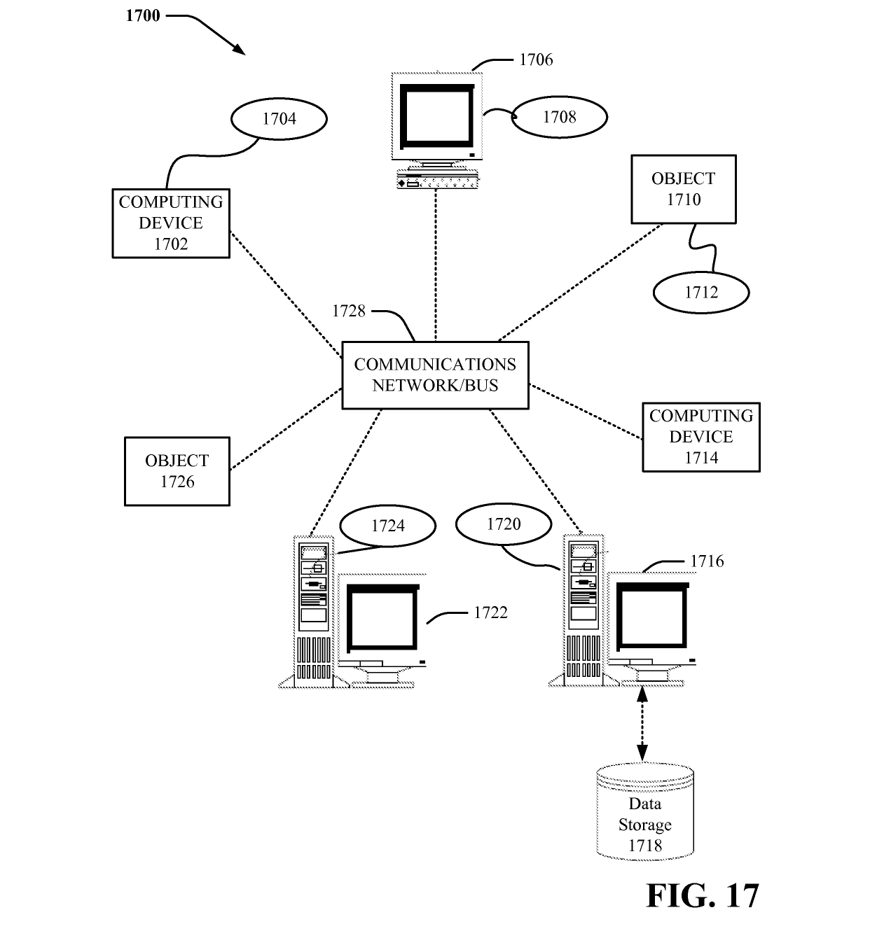

FIG. 17 provides a schematic diagram of an exemplary networked or distributed computing environment. The distributed computing environment comprises computing objects 1722, 1716, etc. and computing objects or devices 1702, 1706, 1710, 1726, 1714, etc., which may include programs, methods, data stores, programmable logic, etc., as represented by applications 1704, 1708, 1712, 1724, 1720. It can be appreciated that computing objects 1722, 1716, etc. and computing objects or devices 1702, 1706, 1710, 1726, 1714, etc. may comprise different devices, such as personal digital assistants (PDAs), audio/video devices, mobile phones, MP3 players, personal computers, laptops, etc.

Each computing object 1722, 1716, etc. and computing objects or devices 1702, 1706, 1710, 1726, 1714, etc. can communicate with one or more other computing objects 1722, 1716, etc. and computing objects or devices 1702, 1706, 1710, 1726, 1714, etc. by way of the communications network 1726, either directly or indirectly. Even though illustrated as a single element in FIG. 17, communications network 1726 may comprise other computing objects and computing devices that provide services to the system of FIG. 17, and/or may represent multiple interconnected networks, which are not shown. Each computing object 1722, 1716, etc. or computing object or device 1702, 1706, 1710, 1726, 1714, etc. can also contain an application, such as applications 1704, 1708, 1712, 1724, 1720, that might make use of an API, or other object, software, firmware and/or hardware, suitable for communication with or implementation of the shared shopping systems provided in accordance with various non-limiting embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the shared shopping systems as described in various non-limiting embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, i.e., roughly a set of instructions or tasks, that requests a service provided by another program or process. The client process utilizes the requested service without having to “know” any working details about the other program or the service itself.

In client/server architecture, particularly a networked system, a client is usually a computer that accesses shared network resources provided by another computer, e.g., a server. In the illustration of FIG. 17, as a non-limiting example, computing objects or devices 1702, 1706, 1710, 1726, 1714, etc. can be thought of as clients and computing objects 1722, 1716, etc. can be thought of as servers where computing objects 1722, 1716, etc., acting as servers provide data services, such as receiving data from client computing objects or devices 1702, 1706, 1710, 1726, 1714, etc., storing of data, processing of data, transmitting data to client computing objects or devices 1702, 1706, 1710, 1726, 1714, etc., although any computer can be considered a client, a server, or both, depending on the circumstances. Any of these computing devices may be processing data, or requesting services or tasks that may implicate the shared shopping techniques as described herein for one or more non-limiting embodiments.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques described herein can be provided standalone, or distributed across multiple computing devices or objects.

In a network environment in which the communications network 1726 or bus is the Internet, for example, the computing objects 1722, 1716, etc. can be Web servers with which other computing objects or devices 1702, 1706, 1710, 1726, 1714, etc. communicate via any of a number of known protocols, such as the hypertext transfer protocol (HTTP). Computing objects 1722, 1716, etc. acting as servers may also serve as clients, e.g., computing objects or devices 1702, 1706, 1710, 1726, 1714, etc., as may be characteristic of a distributed computing environment.

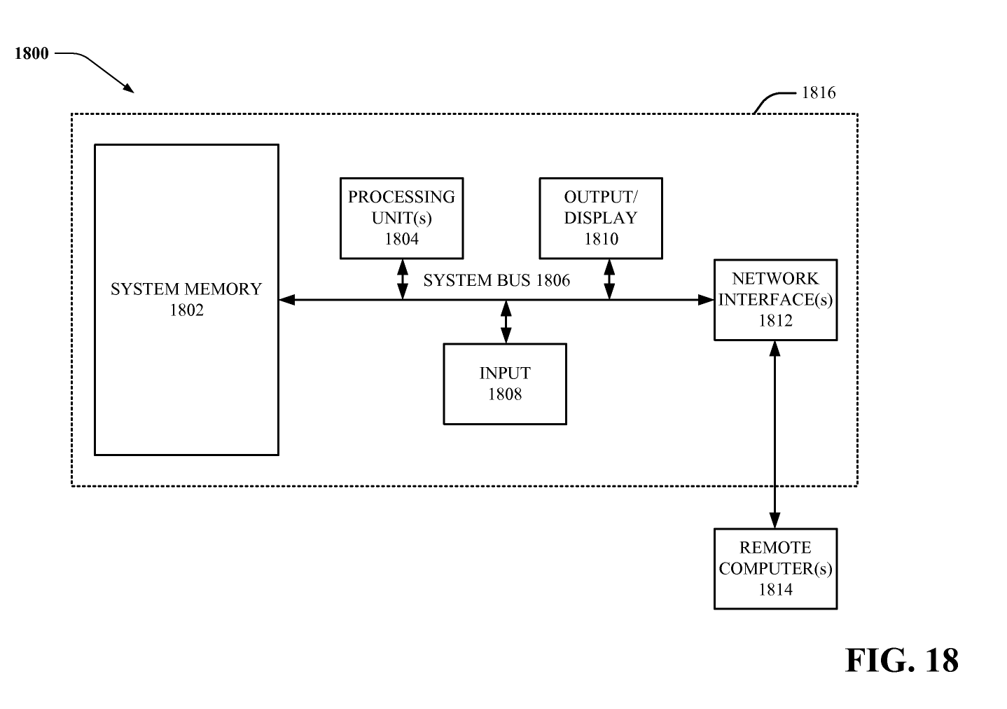

As mentioned, advantageously, the techniques described herein can be applied to any device where it is desirable to facilitate matrix generation and matrix utilization. It is to be understood, therefore, that handheld, portable and other computing devices and computing objects of all kinds are contemplated for use in connection with the various non-limiting embodiments, i.e., anywhere that a device may wish to engage in a shopping experience on behalf of a user or set of users. Accordingly, the below general purpose remote computer described below in FIG. 18 is but one example of a computing device.

Although not required, non-limiting embodiments can partly be implemented via an operating system, for use by a developer of services for a device or object, and/or included within application software that operates to perform one or more functional aspects of the various non-limiting embodiments described herein. Software may be described in the general context of computer-executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is to be considered limiting.

FIG. 18 thus illustrates an example of a suitable computing system environment 1800 in which one or aspects of the non-limiting embodiments described herein can be implemented, although as made clear above, the computing system environment 1800 is only one example of a suitable computing environment and is not intended to suggest any limitation as to scope of use or functionality. Neither should the computing system environment 1800 be interpreted as having any dependency or requirement relating to any one or combination of components illustrated in the exemplary computing system environment 1800.

With reference to FIG. 18, an exemplary remote device for implementing one or more non-limiting embodiments includes a general purpose computing device in the form of a computer 1816. Components of computer 1816 may include, but are not limited to, a processing unit 1804, a system memory 1802, and a system bus 1806 that couples various system components including the system memory to the processing unit 1804.

Computer 1816 typically includes a variety of computer readable media and can be any available media that can be accessed by computer 1816. The system memory 1802 may include computer storage media in the form of volatile and/or nonvolatile memory such as read only memory (ROM) and/or random access memory (RAM). Computer readable media can also include, but is not limited to, magnetic storage devices (e.g., hard disk, floppy disk, magnetic strip), optical disks (e.g., compact disk (CD), digital versatile disk (DVD)), smart cards, and/or flash memory devices (e.g., card, stick, key drive). By way of example, and not limitation, system memory 1802 may also include an operating system, application programs, other program modules, and program data.

A user can enter commands and information into the computer 1816 through input devices 1808. A monitor or other type of display device is also connected to the system bus 1806 via an interface, such as output interface 1812. In addition to a monitor, computers can also include other peripheral output devices such as speakers and a printer, which may be connected through output interface 1812.

The computer 1816 may operate in a networked or distributed environment using logical connections to one or more other remote computers, such as remote computer 1812. The remote computer 1812 may be a personal computer, a server, a router, a network PC, a peer device or other common network node, or any other remote media consumption or transmission device, and may include any or all of the elements described above relative to the computer 1816. The logical connections depicted in FIG. 18 include a network, such local area network (LAN) or a wide area network (WAN), but may also include other networks/buses. Such networking environments are commonplace in homes, offices, enterprise-wide computer networks, intranets and the Internet.

As mentioned above, while exemplary non-limiting embodiments have been described in connection with various computing devices and network architectures, the underlying concepts may be applied to any network system and any computing device or system.

Also, there are multiple ways to implement the same or similar functionality, e.g., an appropriate application programming interface (API), tool kit, driver source code, operating system, control, standalone or downloadable software object, etc. which enables applications and services to take advantage of techniques provided herein. Thus, non-limiting embodiments herein are contemplated from the standpoint of an API (or other software object), as well as from a software or hardware object that implements one or more aspects of the shared shopping techniques described herein. Thus, various non-limiting embodiments described herein can have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used, for the avoidance of doubt, such terms are intended to be inclusive in a manner similar to the term “comprising” as an open transition word without precluding any additional or other elements.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it is to be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described infra, methodologies that may be implemented in accordance with the described subject matter can also be appreciated with reference to the flowcharts of the various figures. While for purposes of simplicity of explanation, the methodologies are shown and described as a series of blocks, it is to be understood and appreciated that the various non-limiting embodiments are not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

As discussed herein, the various embodiments disclosed herein may involve a number of functions to be performed by a computer processor, such as a microprocessor. The microprocessor may be a specialized or dedicated microprocessor that is configured to perform particular tasks according to one or more embodiments, by executing machine-readable software code that defines the particular tasks embodied by one or more embodiments. The microprocessor may also be configured to operate and communicate with other devices such as direct memory access modules, memory storage devices, Internet-related hardware, and other devices that relate to the transmission of data in accordance with one or more embodiments. The software code may be configured using software formats such as Java, C++, XML (Extensible Mark-up Language) and other languages that may be used to define functions that relate to operations of devices required to carry out the functional operations related to one or more embodiments. The code may be written in different forms and styles, many of which are known to those skilled in the art. Different code formats, code configurations, styles and forms of software programs and other means of configuring code to define the operations of a microprocessor will not depart from the spirit and scope of the various embodiments.

Within the different types of devices, such as laptop or desktop computers, hand held devices with processors or processing logic, and also possibly computer servers or other devices that utilize one or more embodiments, there exist different types of memory devices for storing and retrieving information while performing functions according to the various embodiments. Cache memory devices are often included in such computers for use by the central processing unit as a convenient storage location for information that is frequently stored and retrieved. Similarly, a persistent memory is also frequently used with such computers for maintaining information that is frequently retrieved by the central processing unit, but that is not often altered within the persistent memory, unlike the cache memory. Main memory is also usually included for storing and retrieving larger amounts of information such as data and software applications configured to perform functions according to one or more embodiments when executed, or in response to execution, by the central processing unit. These memory devices may be configured as random access memory (RAM), static random access memory (SRAM), dynamic random access memory (DRAM), flash memory, and other memory storage devices that may be accessed by a central processing unit to store and retrieve information. During data storage and retrieval operations, these memory devices are transformed to have different states, such as different electrical charges, different magnetic polarity, and the like. Thus, systems and methods configured according to one or more embodiments as described herein enable the physical transformation of these memory devices. Accordingly, one or more embodiments as described herein are directed to novel and useful systems and methods that, in the various embodiments, are able to transform the memory device into a different state when storing information. The various embodiments are not limited to any particular type of memory device, or any commonly used protocol for storing and retrieving information to and from these memory devices, respectively.

Embodiments of the systems and methods described herein facilitate the management of data input/output operations. Additionally, some embodiments may be used in conjunction with one or more conventional data management systems and methods, or conventional virtualized systems. For example, one embodiment may be used as an improvement of existing data management systems.

Although the components and modules illustrated herein are shown and described in a particular arrangement, the arrangement of components and modules may be altered to process data in a different manner. In other embodiments, one or more additional components or modules may be added to the described systems, and one or more components or modules may be removed from the described systems. Alternate embodiments may combine two or more of the described components or modules into a single component or module.

Although some specific embodiments have been described and illustrated as part of the disclosure of one or more embodiments herein, such embodiments are not to be limited to the specific forms or arrangements of parts so described and illustrated. The scope of the various embodiments are to be defined by the claims appended hereto and their equivalents.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium.

Computing devices typically include a variety of media, which can include computer-readable storage media and/or communications media, which two terms are used herein differently from one another as follows. Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other. As used herein, unless explicitly or implicitly indicating otherwise, the term “set” is defined as a non-zero set. Thus, for instance, “a set of criteria” can include one criterion, or many criteria.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A system, comprising:
a memory having computer executable components stored thereon; and
a processor, communicatively coupled to the memory, configured to facilitate execution of the computer executable components, the computer executable components, comprising:
a tagging component configured to assign a tag to a content element in a media item, wherein the tag is assigned to an image associated with the content element; and
a matching component configured to associate the tag with one or more other tags based at least in part on information associated with the tag.

2. The system of claim 1, wherein the image is a thumbnail image associated with the content element.

3. The system of claim 1, wherein the matching component is further configured to associate the image with one or more other images.

4. The system of claim 1, wherein at least one of the one or more other tags are assigned to at least one other content element in at least one other media item.

5. The system of claim 1, wherein the matching component is further configured to group the tag with the one or more other tags.

6. The system of claim 1, wherein the matching component is further configured to find at least one other media item based on the information associated with the tag.

7. The system of claim 1, wherein the matching component is further configured to associate the tag with one or more sources of information.

8. The system of claim 1, wherein the information associated with the tag includes at least one keyword associated with the tag.

9. The system of claim 1, wherein the information associated with the tag includes a location of the tag within the media item.

10. The system of claim 1, further comprising a presentation component configured to present the tag along with the one or more other tags based at least in part on the information associated with the tag.

11. A method, comprising:
employing at least one processor to execute computer executable instructions stored on at least one tangible computer readable medium to perform operations, comprising:
locating a content element in a media item;
assigning a tag to the content element in the media item; and
associating the tag with at least one other tag based at least in part on information associated with the tag.

12. The method of claim 11, further comprising grouping the tag with the at least one other tag based at least in part on the information associated with the tag.

13. The method of claim 11, further comprising assigning the tag to an image associated with the content element.

14. The method of claim 11, further comprising finding at least one other media item based on the information associated with the tag.

15. The method of claim 11, further comprising assigning a relevancy score to the at least one other tag based on a comparison of the information with other information associated with the at least one other tag.

16. A method, comprising:
assigning, by the system, an image to a content element in a media item; and
associating, by the system, the image with one or more other images based on information associated with the image.

17. The method of claim 16, further comprising grouping the image with the one or more other images based at least on the information associated with the image.

18. The method of claim 16, further comprising presenting the image with the one or more other images based on the information associated with the image.

19. A tangible computer-readable storage medium comprising computer-readable instructions that, in response to execution, cause a computing system including a processor to perform operations, comprising:
locating a content element in a media item;
assigning a tag and an image to the content element in the media item; and
associating the tag with one or more other tags based at least in part on information associated with the tag.

20. The tangible computer-readable storage medium of claim 19, further comprising grouping the tag with the one or more other tags based at least in part on the information associated with the tag.
